(19) United States
(12) Patent Application Publication
(10) Pub. No.: US 2012/0151048 A1
(43) Pub. Date: Jun. 14, 2012

(54) COMMUNICATION DEVICE, APPARATUS, SYSTEM, AND METHOD OF SETTING COMMUNICATION DEVICE, AND COMMUNICATION DEVICE SETTING PROGRAM

(76) Inventor: Kazuki KITAZAWA, Kanagawa (JP)

(21) Appl. No.: 13/311,909

(22) Filed: Dec. 6, 2011

(30) Foreign Application Priority Data
Dec. 10, 2010 (JP) 2010-275688

(51) Int. Cl. G06F 15/173

(52) U.S. Cl. 709/224

(57) ABSTRACT

A communication device is assigned with a first address that is uniquely assigned to the communication device, and a second address that is commonly assigned to communication devices of the same type. An information processing apparatus, which is connected to the communication device through a network, sends a communication packet that is addressed to the second address and includes a request for setting device settings information of the communication device. The communication device, when it is determined to respond to the communication packet, sends a communication packet including current device settings information of the information processing apparatus to the information processing apparatus.

### CROSS-REFERENCE TO RELATED APPLICATIONS

This patent application is based on and claims priority pursuant to 35 U.S.C. §119 to Japanese Patent Application No. 2010-275688, filed on Dec. 10, 2010, in the Japan Patent Office, the entire disclosure of which is hereby incorporated herein by reference.

### BACKGROUND

1. Field

The present invention generally relates to a communication device, apparatus, system, and method of setting the communication device, and a recording medium storing a plurality of instructions that cause a processor to perform a communication device setting method.

2. Discussion of the Background

Ethernet converters allow an information processing apparatus that communicates via Ethernet to communicate wirelessly. While the Ethernet converter is set through an information processing apparatus before use, setting various parameters of the Ethernet convert has been cumbersome as the following procedure is usually required. Assuming that the Ethernet converter is added to a network system now in use, an IP address of the information processing apparatus is changed according to an IP address of the Ethernet converter that is previously set, before the information processing apparatus is connected to the Ethernet converter. Through the information processing apparatus now connected to the Ethernet converter, the IP address of the Ethernet converter is changed according to settings of the current network system. The IP address of the information processing apparatus is changed back to the original IP address, after being disconnected from the Ethernet converter.

U.S. Patent Application Registration No. 7,805,504B2 describes a network device, which operates in a configuring mode and a normal operational mode. In the configuration mode, when a personal computer (PC) sends a name resolution request that is addressed to an URI arbitrarily input by a user at the PC, a DNS server returns an IP address of the network device in response to such request, regardless of the URI in the request. The PC then sends a further request addressing the IP address of the network device to allow the user at the PC to set the network device. While this allows the user at the PC to set the network device without requiring the change in the IP address of the PC, the network device returns the IP address of the network device to any request received in the configuring mode. Accordingly, this technique requires the user to separate the network device from a current network and connect the network device to only the PC through a cable.

### SUMMARY

One aspect of the present invention is to provide a technique that allows a user to easily set device settings information of a communication device, using an information processing apparatus without changing a current network configuration.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a hardware structure of an Ethernet converter, according to an example embodiment of the present invention;

FIG. 2 is a schematic block diagram illustrating a hardware structure of an information processing apparatus, according to an example embodiment of the present invention;

FIG. 3 is a schematic block diagram illustrating a configuration of a network system including the Ethernet converter of FIG. 1 and the information processing apparatus of FIG. 2;

FIG. 4 is a flowchart illustrating operation of determining whether to respond to a communication packet received from the information processing apparatus of FIG. 2, performed by the Ethernet converter of FIG. 1, according to an example embodiment of the present invention;

FIG. 5 is a flowchart illustrating operation of determining whether to respond to a communication packet received from the information processing apparatus of FIG. 2, performed by the Ethernet converter of FIG. 1, according to another example embodiment of the present invention;

FIG. 6 is a flowchart illustrating operation of determining whether to allow a user to set the Ethernet converter of FIG. 1, performed by the information processing apparatus of FIG. 2, according to an example embodiment of the present invention;

FIG. 7 is a flowchart illustrating operation of determining whether to allow a user to set the Ethernet converter of FIG. 1, performed by the information processing apparatus of FIG. 2, according to an example embodiment of the present invention;

FIG. 8 is a flowchart illustrating operation of detecting another Ethernet converter or apparatus on a network, performed by the information processing apparatus of FIG. 2, according to an example embodiment of the present invention;

FIG. 9 is a flowchart illustrating operation of detecting another Ethernet converter or apparatus on a network, performed by the information processing apparatus of FIG. 2, according to an example embodiment of the present invention;

FIG. 10 is a data sequence diagram illustrating operation of setting the Ethernet converter of FIG. 1, performed by the network system of FIG. 3, according to an example embodiment of the present invention;

FIG. 11 is a flowchart illustrating operation of determining whether the Ethernet converter of FIG. 1 is connected, performed by the information processing apparatus of FIG. 2, according to an example embodiment of the present invention;

FIG. 12 is a flowchart illustrating operation of responding to a communication packet received from the information processing apparatus of FIG. 2, performed by the Ethernet converter of FIG. 1, according to an example embodiment of the present invention;

FIG. 13 is a data sequence diagram illustrating operation of setting the Ethernet converter of FIG. 1, performed by the information processing apparatus of FIG. 2, according to an example embodiment of the present invention; and

FIG. 14 is a flowchart illustrating operation of determining whether the Ethernet converter of FIG. 1 is connected, performed by the information processing apparatus of FIG. 2, according to an example embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

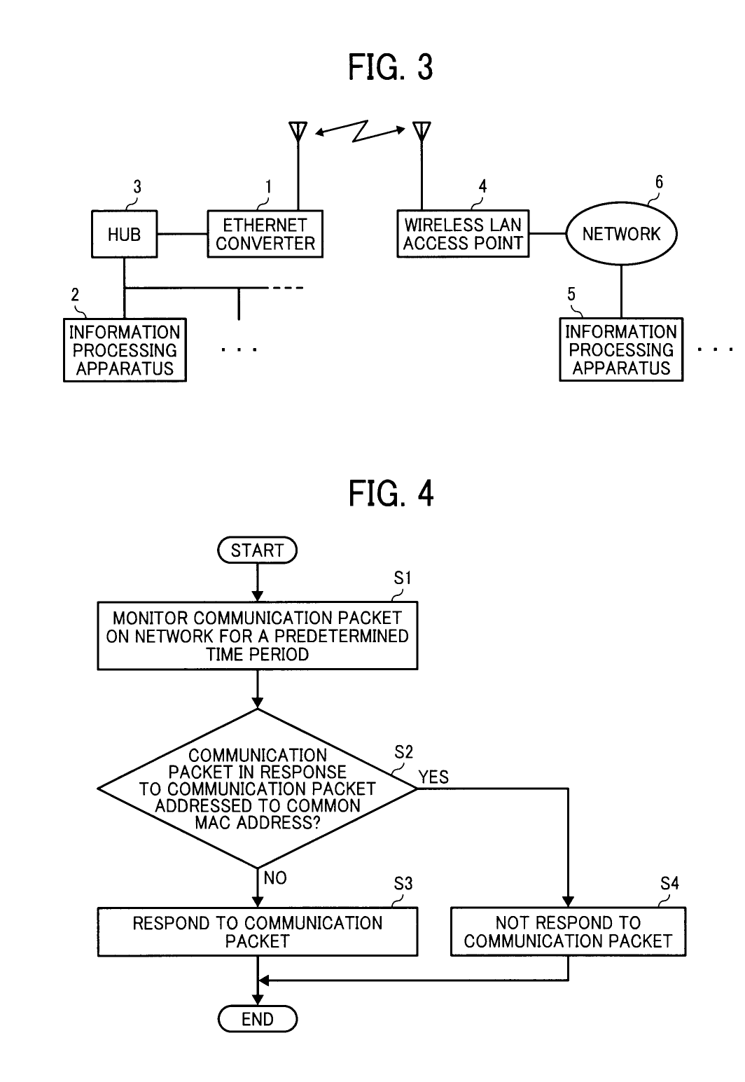

FIG. 3 illustrates a configuration of a communication system according to an example embodiment of the present invention. The communication system, which may be referred to as a network system, includes at least one network including a plurality of apparatuses that communicate with one another over Ethernet. In order to allow communication with another network over a wireless network, an Ethernet converter is provided in the network having the apparatuses communicating via Ethernet. More specifically, the communication system of FIG. 3 includes an Ethernet converter 1, and a plurality of information processing apparatuses 2 that are connected to the Ethernet converter 1 through an Ethernet cable via a hub 3. The communication system of FIG. 3 further includes a wireless local area network (LAN) access point 4, and a plurality of information processing apparatuses 5 that are connected to the wireless LAN access point 4 through an Ethernet cable via a network 6.

The Ethernet converter 1, which may be referred to as a communication device, is connected to the wireless LAN access point 4 through a wireless network according to the wireless LAN standards such as IEEE 802.11 a/g. The Ethernet converter is provided with a bridge function of converting Ethernet data to wireless LAN data, or converting wireless LAN data to Ethernet data. With this bridge function, any one of the information processing apparatuses 2 connected to the hub 3 and any one of the information processing apparatuses 5 on the network 6 communicate with each other over a wireless network.

The information processing apparatuses 2 and 5 may be each implemented by any apparatus that is capable of communicating with another apparatus via Ethernet, such as a personal computer (PC), facsimile, scanner, printer, copier, or multifunctional copier (MFP). The wireless LAN access point 4 communicates with the Ethernet converter 1 over a wireless network to allow communication between the information processing apparatuses 2 and the information processing apparatuses 5 over a wireless LAN.

The network 6 includes the Internet and a LAN according to a TCP/IP protocol, and connects the wireless LAN access point 4 and the information processing apparatus 5 through the Ethernet cable. The information processing apparatuses 2 communicate with one another through the Ethernet cable via the hub 3.

In this communication system, the Ethernet converter 1 and the wireless LAN access point 4 communicate over a wireless network to allow the information processing apparatus 2 to communicate with the information processing apparatuses 5 on the network 6 through the Ethernet converter 1, thus exchanging data with each other.

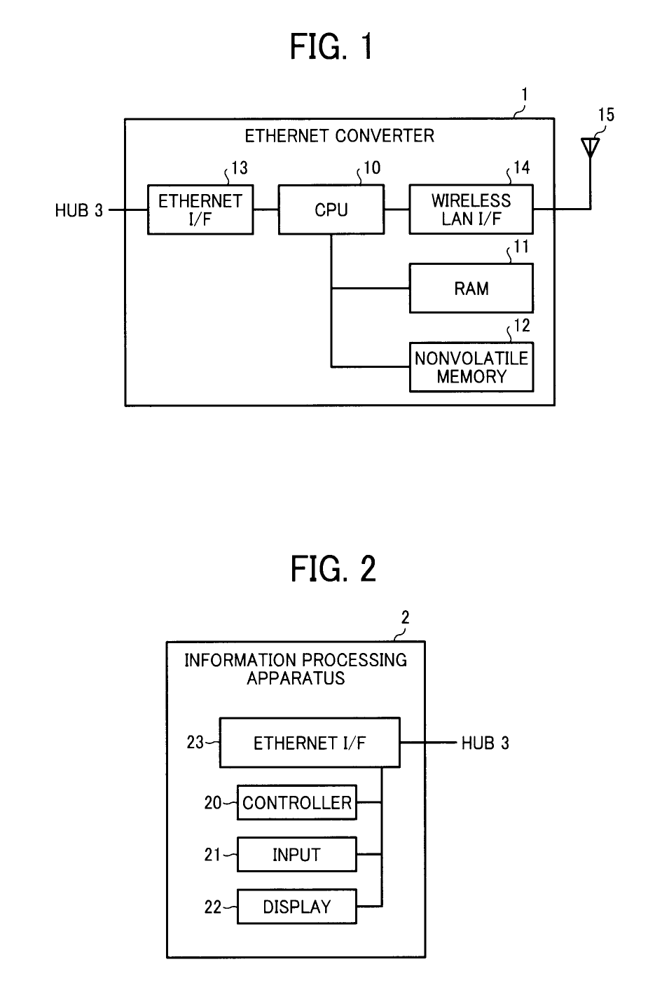

FIG. 1 is a schematic block diagram illustrating a hardware structure of the Ethernet converter 1 of FIG. 3. As illustrated in FIG. 1, the Ethernet converter 1 includes a central processing unit (CPU) 10, a random access memory (RAM) 11, a nonvolatile memory 12, an Ethernet interface (I/F) 13, a wireless LAN interface (I/F) 14, and an antenna 15.

The CPU 10 controls entire operation of the Ethernet converter 1, and processes various data. The RAM 11 deploys thereon a control program stored in the nonvolatile memory 12, and temporarily stores therein various calculation results output by the CPU 10 when executing the control program. According to the control program, the CPU 10 performs conversion between Ethernet data and Wireless LAN data.

The nonvolatile memory 12 is a storage device, which stores therein the control program to be executed by the CPU 10, various parameters including a parameter used for setting the wireless LAN to establish wireless communication with the information processing apparatus 2 such as information regarding ESSID or 802.11 a/g, and device settings information used by the Ethernet converter 1 to communicate with another apparatus such as information regarding data encryption for the wireless LAN communication.

The Ethernet I/F 13 controls input or output of data with respect to the information processing apparatus 2 through the Ethernet cable according to the Ethernet LAN standards. The wireless LAN I/F 14 controls transmission or reception of data with the wireless LAN access point 4 using the antenna 15, for example, according to the IEEE 802.11a/g standards.

In this example of the Ethernet converter 1, the Ethernet I/F 13 is provided with the communication function, the nonvolatile memory 12 is provided with the storage function, and the CPU 10 is provided with the setting function and the controlling function.

FIG. 2 is a schematic block diagram illustrating a hardware structure of the information processing apparatus 2 of FIG. 3. In the following examples, it is assumed that the information processing apparatus 2 is implemented by a PC.

Referring to FIG. 2, the information processing apparatus 2 includes a controller 20, an input 21, a display 22, and an Ethernet I/F 23.

The controller 20 is implemented by a microcomputer including a CPU, ROM, and RAM. The controller 20 controls entire operation of the information processing apparatus 2. The controller 20 provides the function of controlling the information processing apparatus 2.

The input 21 is an input device such as a keyboard, pointing device, etc. The input 21 allows a user to input various instructions such as an instruction regarding settings of the Ethernet converter 1, for example, through a settings screen displayed through the display 22.

The display 22 is a display device such as a liquid crystal display (LCD). The display 22 displays various screens to the user such as the settings screen that allows the user to set various settings of the Ethernet converter 1.

The Ethernet converter I/F 23 controls input or output of data with respect to the Ethernet converter 1 through the Ethernet cable according to the Ethernet LAN standards. The Ethernet I/F 23 provides the function of transmitting or receiving data via Ethernet.

The information processing apparatus 5 is substantially similar in structure to the information processing apparatus 2.

Alternatively, the information processing apparatus 2 or 5 may be implemented by a MFP. In such case, in addition to the above-described devices, the information processing apparatus 2 or 5 is provided with a scanner and a printer, each of which operate under control of the controller 20. The scanner reads an original document into image data. The printer prints out the image data as a printed image. With the scanner and the printer, the MFP performs the functions of scanning, printing, and copying. Further, the MFP functions as a facsimile by transmitting the scanned image data through a communication device using a published switched telephone network. Further, the MFP functions as a data transmitting device that transmits image data through the Ethernet I/F 23.

Now, operation of setting the Ethernet converter 1, performed by the information processing apparatus 2, is explained. In this example, it is assumed that the Ethernet converter 1 previously stores two different types of MAC addresses of the Ethernet converter 1 in the nonvolatile memory 12. The MAC addresses include a specific MAC address and a common MAC address. The specific MAC address is uniquely assigned to the Ethernet converter 1 such that it can be used to distinguish the Ethernet converter 1 from any other Ethernet converter, the wireless LAN access point 4, any other information processing apparatus 2 or 5, or any other device in the communication system of FIG. 3. The common MAC address is common to Ethernet converters of the same type. The common MAC address is assigned, for example, by a provider, i.e., a manufacturer of the Ethernet converters including the Ethernet converter 1, before shipping.

Before starting operation of setting the Ethernet converter 1 through the information processing apparatus 2, the information processing apparatus 2 is installed with a specialized application program, which allows the information processing apparatus 2 to input or change various parameters of the device settings information of the Ethernet converter 1. Such specialized application program may be provided by the manufacturer of the Ethernet converter 1 in any form, for example, in a recording medium. Alternatively, the user may download the specialized application program from the network onto the information processing apparatus 2. Alternatively, the Ethernet converter 1 may previously store the specialized application program. When connection with the information processing apparatus 2 is detected, the specialized application program may be installed onto the information processing apparatus 2.

With execution of the specialized application program, the specialized application program notifies the information processing apparatus 2 of the common MAC address of the Ethernet converter 1 that is common to Ethernet converters. The information processing apparatus 2 thus knows the common MAC address of the Ethernet converter 1 before starting operation of setting the Ethernet converter 1. Further, at least a portion of the specialized application program may be installed onto the information processing apparatus 2.

Further, the common MAC address is used only when the Ethernet converter 1 is set, for example, through the information processing apparatus 2. The specialized application program causes the Ethernet converter 1 to switch to a settings mode. In the settings mode, the Ethernet converter 1 transmits data of a settings screen to the information processing apparatus 2. The information processing apparatus 2 displays a settings screen based on the settings screen data to allow the user to set various settings information regarding the Ethernet converter 1 (“device settings information”) including, for example, an IP address of the Ethernet converter 1, and encryption information related to wireless communication. At any time other than the time when the Ethernet converter 1 is set, or when the Ethernet converter 1 is not in the settings mode, the specific MAC address that is uniquely assigned to the Ethernet converter 1 is used to communicate with the other apparatus on the network.

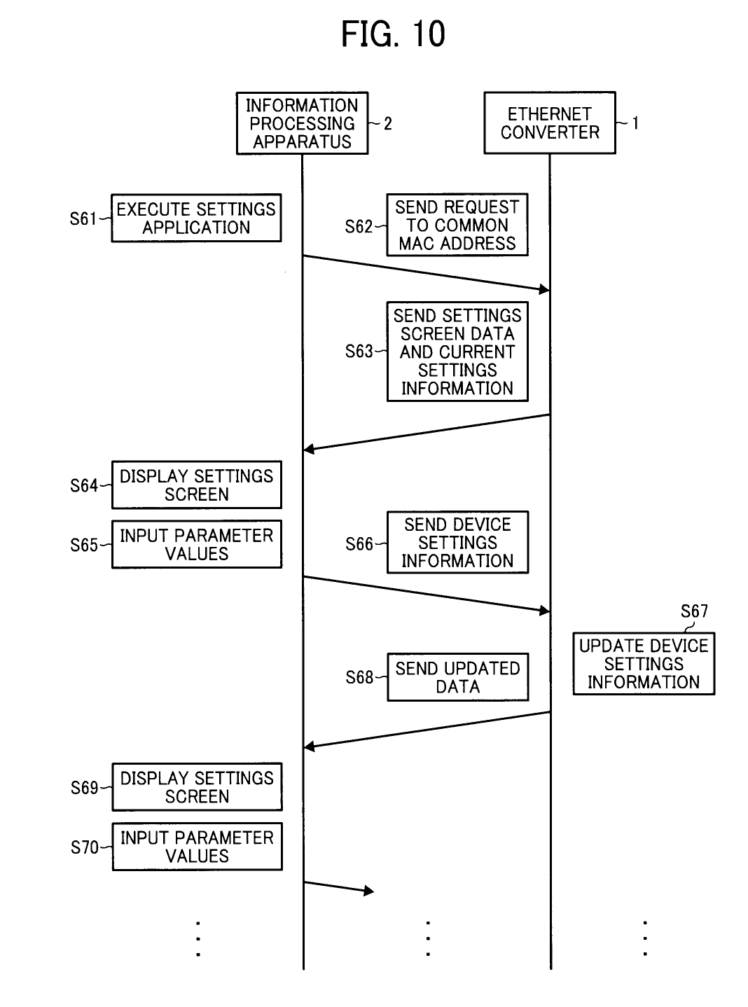

Referring now to FIGS. 10 to 14, operation of setting device settings information of the Ethernet converter 1 is explained according to an example embodiment of the present invention.

Referring to FIG. 10, operation of setting device settings information of the Ethernet converter 1, performed by the network system of FIG. 3, is explained according to an example embodiment of the present invention.

At S61, the information processing apparatus 2 calls for the specialized application program for setting the Ethernet converter 1 (“settings application”) to request the Ethernet converter 1 to switch to a settings mode to start setting operation. For example, when a user instruction for starting setting operation is received through the input 21, the controller 20 executes the settings application program to start setting operation for the Ethernet converter 1.

At S62, the controller 20 of the information processing apparatus 2 causes the Ethernet I/F 23 to send a communication packet of a request for settings mode that is addressed to the common MAC address common to the Ethernet converters, to the Ethernet converter 1, via Ethernet. As described above, the common MAC address of the Ethernet converter 1 is previously notified to the information processing apparatus 2.

At S63, the Ethernet converter 1 sends data of a settings screen and current device settings information to the information processing apparatus 2. More specifically, when the CPU 10 (FIG. 1) receives the communication packet through the Ethernet I/F 13, the CPU 10 determines whether the address of the communication packet is the common MAC address. When it is determined that the address of the communication packet is the common MAC address and that the communication packet includes the request for settings mode, the CPU 10 reads out the settings screen data such as data of a screen to be displayed through a browser, and the current device settings information, from the nonvolatile memory 12. The CPU 10 further transmits the obtained information to the information processing apparatus 2 through the Ethernet I/F 13.

At S64, the information processing apparatus 2 displays the settings screen that reflects the settings screen data and the device settings information received from the Ethernet converter 1. The controller 20, which receives the settings screen data and the device settings information through the Ethernet I/F 23, causes the display 22 to display the settings screen based on the received information such that the current device settings information of the Ethernet converter 1 is displayed on the settings screen, for example, using the browser previously installed onto the information processing apparatus 2.

At S65, the information processing apparatus 2 receives a user input, such as various parameters of settings information, through the input 21. For example, the controller 20 receives a user input of various parameters with respect to device settings information of the Ethernet converter 1 through the input 21.

At S66, the information processing apparatus 2 transmits updated device settings information to the Ethernet converter 1. More specifically, when the input 21 receives a user input for changing or inputting various parameters of device settings information, the controller 20 transmits a communication packet of such updated device settings information that is addressed to the common MAC address through the Ethernet I/F 23.

At S67, the Ethernet converter 1 changes the current device settings information to reflect the updated device settings information that is received from the information processing apparatus 2. When the CPU 10 determines that the communication packet received from the information processing apparatus 2 is addressed to the common MAC address and that communication packet includes the updated device settings information, the CPU 10 updates the current device settings information stored in the nonvolatile memory 12 with the updated device settings information that is extracted from the communication packet.

At S68, the Ethernet converter 1 transmits updated data that reflects the updated device settings information received from the information processing apparatus 2 to the information processing apparatus 2. The CPU 10 transmits the updated data that includes the updated device settings information to the information processing apparatus 2 through the Ethernet I/F 13.

At S69, the controller 20 of the information processing apparatus 2, which receives the updated device settings information from the Ethernet converter 1 through the Ethernet I/F 23, causes the display 22 to display the received device settings information on the settings screen.

At S70, the information processing apparatus 2 waits for further user input regarding various parameters of settings information of the Ethernet converter 1.

As described above, the user at the information processing apparatus 2 does not have to obtain an IP address of the Ethernet converter 1 before starting setting operation, or change an IP address of the information processing apparatus 2 before starting setting operation. Since the information processing apparatus 2 can communicate with the Ethernet converter 1 using the common MAC address that is previously assigned to the Ethernet converters, the workload of the user at the information processing apparatus 2 is greatly suppressed.

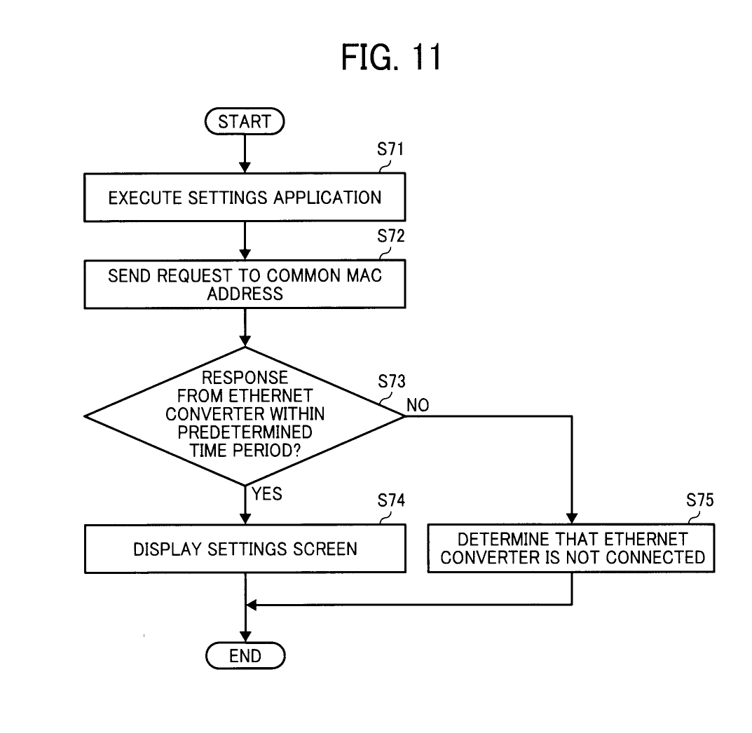

The above-described example operation of FIG. 10 assumes that the Ethernet converter 1 is connected to the information processing apparatus 2 such that the Ethernet converter 1 is communicable with the information processing apparatus 2. However, the Ethernet converter 1 may not be connected to the information processing apparatus 2, or may have a trouble in communicating with the information processing apparatus 2. During operation of FIG. 10, the information processing apparatus 2 determines whether the Ethernet converter 1 is connected to the information processing apparatus 2 as described below referring to FIG. 11.

Referring now to FIG. 11, operation of determining whether the Ethernet converter 1 is connected to the information processing apparatus 2, performed by the information processing apparatus 2, is explained according to an example embodiment of the present invention.

At S71, the controller 20 of the information processing apparatus 2 calls the specialized application program to request for settings mode to start setting operation of the Ethernet converter 1, in a substantially similar manner as described above referring to S61 of FIG. 10. At S72, the controller 20 transmits a communication packet of a request, addressed to the common MAC address, to the Ethernet converter 1, in a substantially similar manner as described above referring to S62 of FIG. 10.

At S73, the controller 20 determines whether there is any response received from the Ethernet converter 1 within a predetermined time period. For example, the controller 20 is provided with a counter that counts a time period to output a counter value, and a nonvolatile memory of the information processing apparatus 2 stores a predetermined value of the counter value. The controller 20 determines whether the counter value of the timer reaches the predetermined value stored in the nonvolatile memory to determine whether the response is received within the predetermined time period. In this example, the predetermined value of the counter value may be set by default or changed according to the user preference.

When it is determined that the response is received within the predetermined time period (“YES” at S73), the operation proceeds to S74 to continue operation of setting device settings information of the Ethernet converter 1. For example, as described above referring to FIG. 10, the information processing apparatus 2 allows the user to input or change device settings information through the settings screen.

When it is determined that the response is not received within the predetermined time period (“NO at S73), the operation proceeds to S75 to determine that the Ethernet converter 1 is not connected. In such case, the information processing apparatus 2 causes the display 22 to display a message indicating that the Ethernet converter 1 is not connected, and the operation ends in error.

As described above, even when the information processing apparatus 2 receives no response in response to the communication packet of the request for settings mode, the user at the information processing apparatus 2 is notified of such error.

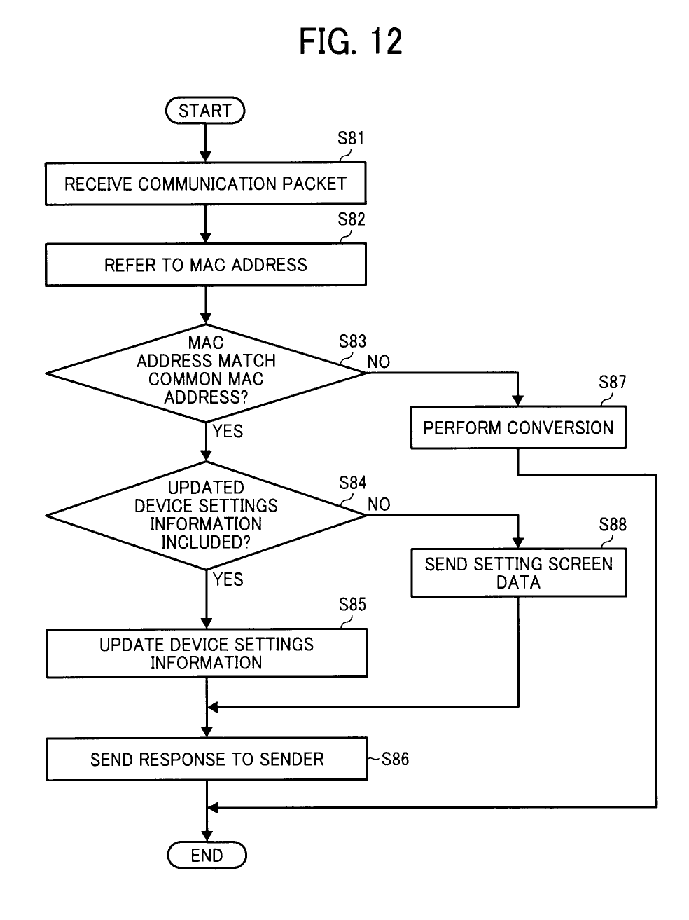

Referring now to FIG. 12, operation of responding to a communication packet received from the information processing apparatus 2, performed by the Ethernet converter 1, is explained according to an example embodiment of the present invention.

At S81, the CPU 10 receives the communication packet through the Ethernet I/F 13. At S82, the CPU 10 extracts the MAC address from the communication packet. At S23, the CPU 10 determines whether the MAC address extracted from the communication packet matches the common MAC address. When it is determined that the extracted MAC address does not match the common MAC address (“NO” at S83), the operation proceeds to S87. This includes the case in which the extracted MAC address matches the specific MAC address of the Ethernet converter 1. At S87, the Ethernet converter 1 performs conversion, and the operation ends. More specifically, at S87, the Ethernet converter 1 converts from the wireless LAN data received from the wireless LAN I/F 14 to Ethernet data, or converts from the Ethernet data received from the Ethernet I/F 13 to wireless LAN data.

When it is determined that the extracted MAC address matches the common MAC address (“YES” at S83), the operation proceeds to S84. At S84, the CPU 10 determines whether the communication packet includes updated device settings information of the Ethernet converter 1 such as a request for updating the device settings information. When it is determined that the communication packet includes the updated device settings information (“YES” at S84), the operation proceeds to S85 to update the current device settings information to reflect the updated device settings information extracted from the communication packet. At S86, the CPU 10 transmits the updated device settings information to the information processing apparatus 2 in response to the communication packet, and the operation ends.

When it is determined that the communication packet does not include the updated device settings information, the CPU 10 assumes that the communication packet includes a request for settings mode and the operation proceeds to S88. At S88, the CPU 10 transmits the settings screen data and the current device settings information to the information processing apparatus 2 in response to the communication packet. At S86, the CPU 10 transmits the current device settings information to the information processing apparatus 2 in response to the communication packet, and the operation ends.

The above-described operation of FIG. 12 may be performed in various other ways. In one example, the Ethernet converter 1 may be stored with a specific IP address, which is previously assigned by the provider of the Ethernet converter 1 as the IP address to be used for the settings mode. The IP address for the settings mode may be notified to the information processing apparatus 2 in a substantially similar manner as the common MAC address is notified to the information processing apparatus 2. Only when the Ethernet converter 1 determines that the communication packet is addressed to the common MAC address and the IP address for the settings mode, the Ethernet converter 1 allows the user at the information processing apparatus 2 to perform operation of setting. In such case, after performing S83 of FIG. 12, the operation additionally causes the CPU 10 to determine whether the IP address for the settings mode is included in the communication packet. When it is determined that the IP address for the settings mode is not included in the communication packet, the communication packet is ignored, and the operation ends. When it is determined that the IP address for the settings mode is included in the communication packet, the operation proceeds to S84. Since the Ethernet converter 1 does not respond to the communication packet unless the IP address for the settings mode is extracted, security in the system improves.

In another example, in alternative to or in addition to using the IP address for the settings mode, the Ethernet converter 1 may determine whether to respond to the communication packet received from the information processing apparatus 2, using a vender code of the MAC address of a sender, that is, a vender ID of the MAC address of the information processing apparatus 2. In Ethernet environment, the MAC address is expressed in 48-bit data such that it can be written as “aa-bb-cc-dd-ee-ff” in 16 numbering system. Of this MAC address, the first 24-bit data “aa-bb-cc” is the vender ID that is uniquely assigned to the provider, i.e., the manufacturer, of a specific machine. Using the vender ID, the provider can be identified. For example, assuming that the information processing apparatus 2 is a MFP, and the Ethernet converter 1 is optionally provided by a manufacturer of the MFP, the vender ID of the MAC address (specific MAC address) of the MFP should match the vender ID of the specific MAC address of the Ethernet converter 1. More specifically, in such case, after performing S83 of FIG. 12, the operation additionally causes the CPU 10 of the Ethernet converter 1 to determine whether the vender ID of the MAC address of the information processing apparatus 2, which is extracted from the communication packet, matches the vender ID of the specific MAC address of the Ethernet converter 1. When it is determined that the vender ID of the communication packet does not match the vender ID of the Ethernet converter 1, the communication packet is ignored, and the operation ends. When it is determined that the vender ID of the communication packet matches the vender ID of the Ethernet converter 1, the operation proceeds to S84. Since the Ethernet converter 1 does not respond to the communication packet unless the vender IDs match, security in the system improves.

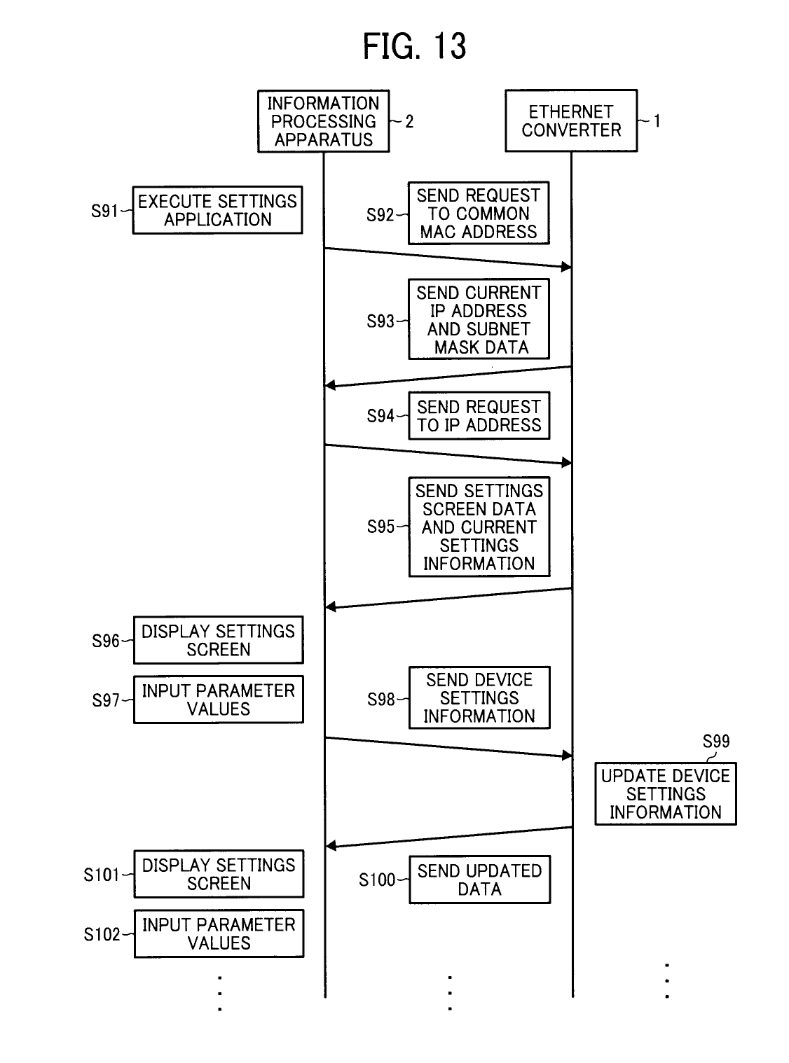

Referring now to FIG. 13, operation of setting device settings information of the Ethernet converter 1, performed by the network system of FIG. 3, is explained according to an example embodiment of the present invention. The operation of FIG. 13 is performed in a substantially similar manner as described above referring to FIG. 10, except that the Ethernet converter 1 sends its IP address in response to the communication packet of the request addressed to the common MAC address.

At S91, the information processing apparatus 2 calls for the specialized application program for setting the Ethernet converter 1 (“settings application”) to request the Ethernet converter 1 to switch to a settings mode to start setting operation. At S92, the controller 20 of the information processing apparatus 2 causes the Ethernet I/F 23 to send a communication packet of a request that is addressed to the common MAC address common to the Ethernet converters, to the Ethernet converter 1, via Ethernet.

At S93, the Ethernet converter 1 sends an IP address of the Ethernet converter 1 and subnet mask information of the Ethernet converter 1 to the information processing apparatus 2, in response to the communication packet. More specifically, when the CPU 10 of the Ethernet converter 1 determines that the address of the communication packet is the common MAC address and the communication packet includes the request for settings mode, the CPU 10 reads out the IP address and the subnet mask information of the Ethernet converter 1 from the nonvolatile memory 12, and sends such information to the information processing apparatus 2 through the Ethernet I/F 13.

At S94, the controller 20 of the information processing apparatus 2 automatically changes the current IP address of the information processing apparatus 2 according to the IP address of the Ethernet converter 1, which is received from the Ethernet converter 1. Using the IP address of the Ethernet converter 1, the Ethernet I/F 23 of the information processing apparatus 2 transmits the communication packet of the request to the Ethernet converter 1.

At S95, the Ethernet converter 1 sends settings screen data and current device settings information to the information processing apparatus 2. More specifically, when the CPU 10 receives the communication packet through the Ethernet I/F 13, the CPU 10 determines whether the address of the communication packet is the IP address of the Ethernet converter 1. When it is determined that the address of the communication packet is the IP address of the Ethernet converter 1 and that the communication packet includes the request for settings mode, the CPU 10 reads out the settings screen data and the current device settings information from the nonvolatile memory 12, and sends such information to the information processing apparatus 2 through the Ethernet I/F 13.

At S96, the information processing apparatus 2 displays the settings screen that reflects the settings screen data and the device settings information received from the Ethernet converter 1. At S97, the information processing apparatus 2 receives a user input, such as various parameters of settings information, through the input 21. At S98, the information processing apparatus 2 transmits updated device settings information to the Ethernet converter 1, as a communication packet addressed to the IP address of the Ethernet converter 1.

At S99, the Ethernet converter 1 changes the current device settings information to reflect the updated device settings information that is received from the information processing apparatus 2. At S100, the Ethernet converter 1 transmits the updated data that reflects the updated device settings information received from the information processing apparatus 2 to the information processing apparatus 2.

At S101, the controller 20 of the information processing apparatus 2, which receives the updated device settings information from the Ethernet converter 1 through the Ethernet I/F 23, causes the display 22 to display the received device settings information on the settings screen. At S102, the information processing apparatus 2 waits for further user input regarding various parameters of settings information of the Ethernet converter 1.

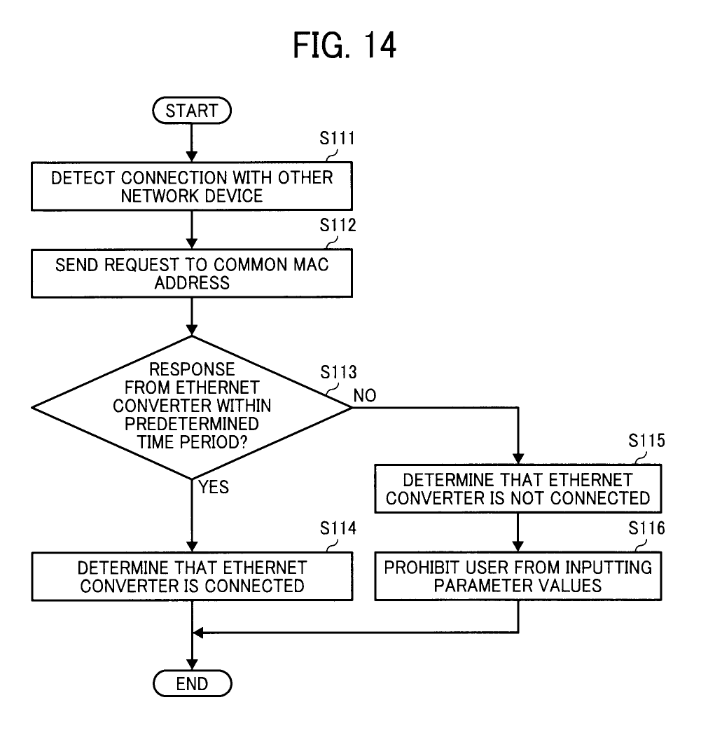

Referring now to FIG. 14, operation of determining whether the Ethernet converter 1 is connected to the information processing apparatus 2, performed by the information processing apparatus 2, is explained according to an example embodiment of the present invention.

At S111, the controller 20 of the information processing apparatus 2 detects connection with an external apparatus such as the Ethernet converter 1 through the Ethernet I/F 23. More specifically, in this example, the Ethernet I/F 23 is provided with a detector that detects electrical connection with another apparatus.

When connection is detected, at S112, the controller 20 of the information processing apparatus 2 calls the specialized application program (“settings application”) to request for settings mode to start setting operation of the Ethernet converter 1, and transmits a communication packet of a request addressing to the common MAC address to the Ethernet converter 1.

At S113, the controller 20 determines whether there is any response received from the Ethernet converter 1 within a predetermined time period, in a substantially similar manner as described above referring to S73 of FIG. 11. When it is determined that the response is received (“YES” at S113), the operation proceeds to S114 to determine that the Ethernet converter 1 is connected to continue operation of setting the Ethernet converter 1.

When it is determined that the response is not received (“NO” at S113), the operation proceeds to S115 to determine that the Ethernet converter 1 is not connected. At S116, the controller 20 of the information processing apparatus 2 prohibits the user from continuing setting operation, and the operation ends in error. Further, at S116, the controller 20 of the information processing apparatus 2 causes the display 22 to display a message indicating that the Ethernet converter 1 is not connected to the user. The user may try to restart the system of the information processing apparatus 2, or re-connect the Ethernet cable to the information processing apparatus 2. After such operation, the information processing apparatus 2 repeats operation of FIG. 14.

As described above referring FIGS. 10 to 14, the Ethernet converter 1 is provided with the common MAC address that is common to Ethernet converters. The information processing apparatus 2, which is notified with the common MAC address, sends a communication packet of request for settings mode, which is addressed to the common MAC address, to the Ethernet converter 1. The Ethernet converter 1 determines that the communication packet is addressed to the common MAC address, and allows the information processing apparatus 2 to set device settings information of the Ethernet converter 1. Using the common MAC address, the user at the information processing apparatus 2 is able to set device settings information of the Ethernet converter 1 without changing the IP address of the information processing apparatus 2 or without changing a network configuration of the network system of FIG. 3.

Referring now to FIGS. 4 to 9, operation of setting device settings information of the Ethernet converter 1 is explained according to another example embodiment of the present invention. In the example case illustrated in FIGS. 10 to 14, if there is more than one Ethernet converter assigned with the common MAC address on the network, or if the common MAC address is the same as a MAC address of any other apparatus on the network, all of the Ethernet converters assigned with the common MAC address or apparatuses assigned with the same MAC address would respond to the communication packet of the request for settings mode. To prevent this problem, in the following examples, the Ethernet converter 1 is caused to determine whether a communication packet is sent from another apparatus in response to the communication packet of the request for settings mode. When it is determined that there is no communication packet being sent in response to the communication packet, the Ethernet converter 1 sends a communication packet in response to the communication packet of the request to the information processing apparatus 2.

FIG. 4 is a flowchart illustrating operation of determining whether to respond to the communication packet received from the information processing apparatus 2, performed by the Ethernet converter 1. The operation of FIG. 4 is performed when the CPU 10 of the Ethernet converter 1 determines that the communication packet of the request for settings mode is received, for example, as described above referring to S83 of FIG. 12.

At S1, the CPU 10 of the Ethernet converter 1 starts monitoring a communication packet on the network for a predetermined time period. In this example, the CPU 10 is provided with a counter that counts a time period to output a counter value, and a random number generator that generates a random number. The CPU 10 determines whether the counter value of the timer reaches the value of random number. When it is determined that the counter value reaches the value of random number, the operation proceeds to S2.

At S2, the CPU 10 determines whether a communication packet is detected, which is transmitted in response to the communication packet of the request for settings mode that is addressed to the common MAC address. More specifically, at S2, the CPU 10 determines that the communication packet in response to the request for settings mode is detected, by checking a sender MAC address and a destination MAC address of the communication packet. When the destination MAC address of such communication packet matches a MAC address of the sender (the information processing apparatus 2) that sends the request, and the sender MAC address of such communication packet matches the common MAC address, the CPU 10 determines that the communication packet is the communication packet that is sent in response to the request for settings mode.

When it is determined that the communication packet in response to the request for settings mode is not detected (“NO” at S2), the operation proceeds to S3. At S3, the CPU 10 transmits a communication packet including device settings data and current device settings information to the information processing apparatus 2 through the Ethernet I/F 13, and the operation continues to allow the information processing apparatus 2 to set device settings information of the Ethernet converter 1, for example, as described above referring to S64 to S70 of FIG. 10.

When it is determined that the communication packet in response to the request for settings mode is detected (“YES” at S2), the operation proceed to S4 to determine not to send a communication packet that allows setting operation in response to the communication packet of the request for settings mode.

Assuming that a plurality of Ethernet converters are connected to the hub 3 (FIG. 3), each of the Ethernet converters monitors for a communication packet in response to the request for settings mode for a predetermined time period that is randomly set for each Ethernet converter. Only when the Ethernet converter determines that there is no communication packet that is sent in response to the request for settings mode for the predetermined time period, the Ethernet converter sends a communication packet in response to the request for settings mode. Since only one Ethernet converter would respond to the communication packet of the request for settings mode, operation of setting is performed with respect to one Ethernet converter 1.

In the above-described example, it is assumed that the CPU 10 is generated with the function of generating a random number. Alternatively, the CPU 10 of each Ethernet converter 1 may be previously stored with a predetermined value, which is randomly assigned before shipping. In such case, the CPU 10 monitors for a predetermined time period set by the predetermined value that is previously stored in its memory such as the nonvolatile memory 12.

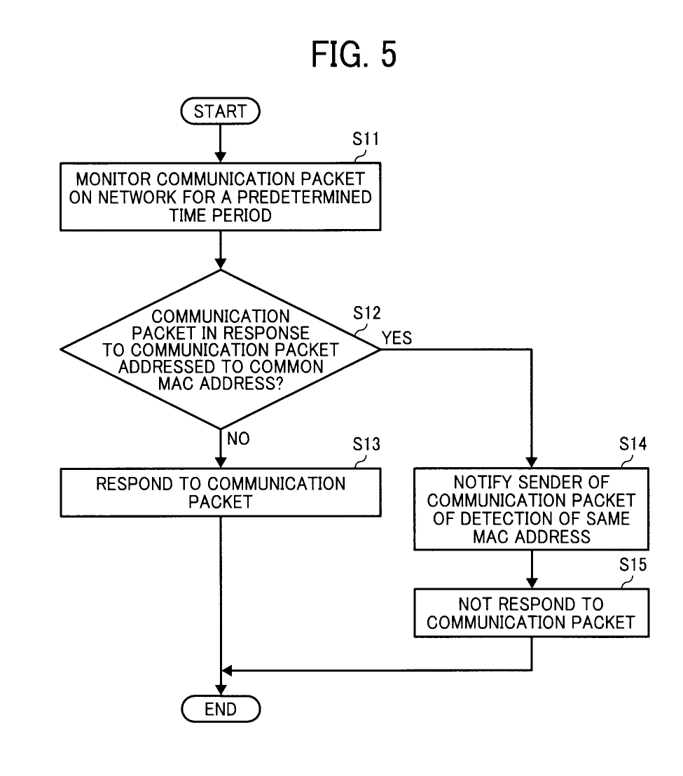

Referring now to FIG. 5, operation of determining whether to respond to the communication packet received from the information processing apparatus 2, performed by the Ethernet converter 1, is explained according to an example embodiment of the present invention.

S11 to S13 are performed in a substantially similar manner as described above referring to S1 to S3 of FIG. 4.

At S12, when the CPU 10 of the Ethernet converter 1 detects a communication packet that is sent in response to the communication packet of request for settings mode, the operation proceeds to S14.

At S14, the CPU 10 of the Ethernet converter 1 sends a communication packet including notification indicating that more than one Ethernet converter assigned with the common MAC address is detected, to the information processing apparatus 2. Alternatively or additionally, at S14, the notification may indicate that at least one apparatus assigned with the same MAC address that is the same with the common MAC address is detected.

At S15, the CPU 10 of the Ethernet converter 1 determines not to respond to the communication packet of the request for settings mode, and the operation ends.

With this notification, the user at the information processing apparatus 2 knows that there is more than one Ethernet converter on the network, which is not finished with setting operation. The user at the information processing apparatus 2 may disconnect at least one Ethernet converter that is most likely to be not in use, from the network. Alternatively or additionally, the user at the information processing apparatus 2 knows that there is more than one apparatus that has the same MAC address with the common MAC address. The user at the information processing apparatus 2 may modify the MAC address of the apparatus having the same MAC address.

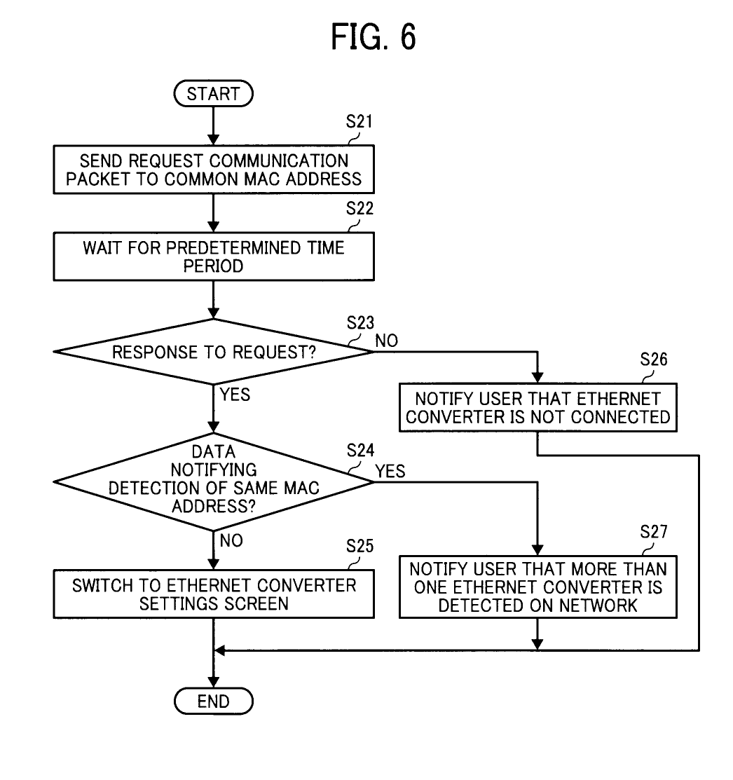

Referring now to FIG. 6, operation of setting device settings information of the Ethernet converter 1, performed by the information processing apparatus 2, is explained according to an example embodiment of the present invention. The operation of FIG. 6 is performed when the information processing apparatus 2 executes the specialized application program (“settings application”) to start setting operation of the Ethernet converter 1.

At S21, the controller 20 of the information processing apparatus 2 sends a communication packet of a request for settings mode that is addressed to the common MAC address, to the Ethernet converter 1, through the Ethernet I/F 23.

At S22, the controller 20 waits for a predetermined time period. As described above referring to FIG. 11, the controller 20 is provided with the counter that counts a time period to output a counter value. When the counter value reaches the predetermined value that is previously set, the operation proceeds to S23.

At S23, the controller 20 determines whether, within the predetermined time period, a communication packet is received from the Ethernet converter 1 in response to the communication packet of the request for settings mode that is sent at S21.

When it is determined that the communication packet is received (“YES” at S23), the operation proceeds to S24 to determine whether the communication packet that is received includes data notifying detection of the same MAC address that is the same with the common MAC address, or data notifying that more than one Ethernet converter is detected. When it is determined that the communication packet does not include such notification data (“NO” at S24), the operation proceeds to S25.

At S25, the controller 20 of the information processing apparatus 2 causes the display 22 to display a settings screen of the Ethernet converter 1 based on information of the communication packet, and the operation continues to perform setting operation. More specifically, at S24, the controller 20 of the information processing apparatus 2 receives the communication packet including the settings screen data and the current device settings information through the Ethernet I/F 23. The controller 20 further causes the display 22 to display a settings screen based on the received information to allow the user to set various parameters of the device settings information.

When it is determined that the communication packet is not received (“NO” at S23), the operation proceeds to S26 to cause the display 22 to display a message indicating that the Ethernet converter 1 is not connected, and the operation ends. With this notification, the user at the information processing apparatus 2 is able to check connection of the Ethernet converter 1.

When it is determined that the communication packet includes data notifying detection of the same MAC address or data notifying detection of more than one Ethernet converter (“YES” at S24), the operation proceeds to S27. At S27, the controller 20 of the information processing apparatus 2 causes the display 22 to display a message indicating that an apparatus with the same MAC address is detected or more than one Ethernet converter is detected on the network, and the operation ends. With this notification, the user at the information processing apparatus 2 is able to modify the network configuration of the network system of FIG. 3.

In any one of the above-described operations of FIGS. 5 and 6, when a communication packet is detected in response to the request for settings mode, the Ethernet converter 1 assumes that an apparatus that sends the communication packet is either the other Ethernet converter assigned with the common MAC address or an apparatus assigned with the same MAC address as the common MAC address. However, the user may want to know whether the communication packet is sent from the other Ethernet converter, or from the other apparatus such as the information processing apparatus 2 connected to the hub 3. In order to distinguish the communication packet that is sent from the Ethernet converters, from the communication packet that is sent from the other network apparatuses such as the information processing apparatuses 2, the Ethernet converter 1 may be caused to generate a communication packet in a predetermined data format specific to the Ethernet converters.

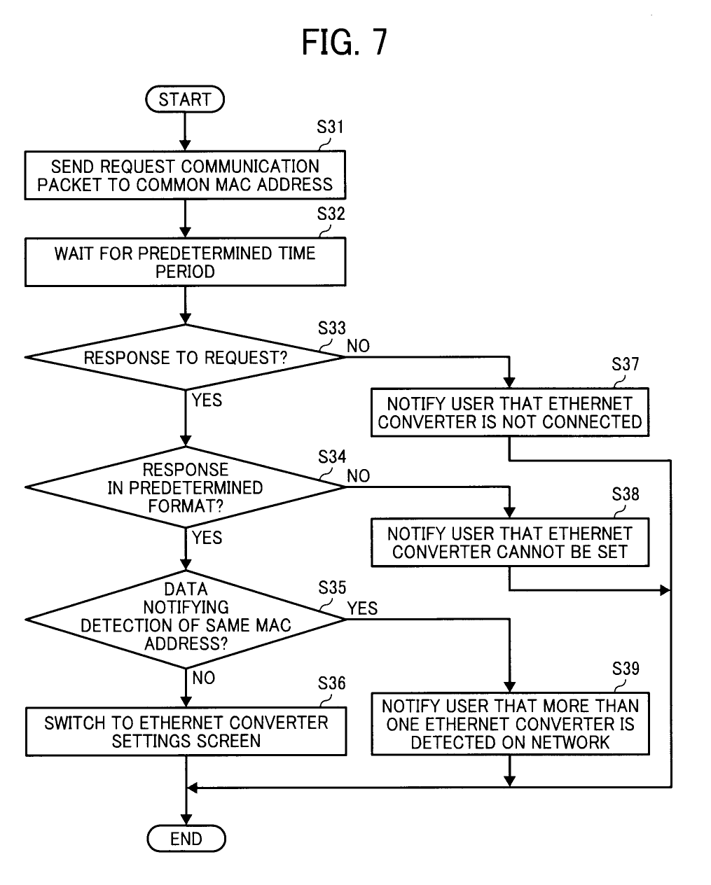

FIG. 7 is a flowchart illustrating operation of setting device settings information of the Ethernet converter 1, performed by the information processing apparatus 2, when the Ethernet converter generates the communication packet in the predetermined data format, according to an example embodiment of the present invention.

S31 to S33 of FIG. 7 are performed in a substantially similar manner as described above referring to S21 to S23 of FIG. 6.

When it is determined that there is any response to the request for settings mode at S33, the operation proceeds to S34. At S34, the controller 20 of the information processing apparatus 2 determines whether the response received at S33 is in a predetermined format. In this example, it is assumed that the Ethernet converters including the Ethernet converter 1 each generates a communication packet in a predetermined data format that is previously determined by the specialized application program. The predetermined data format may be specified using a data size of the communication packet or the contents of data included in the communication packet. When it is determined that the communication packet that is received in response to the request for settings mode is in the predetermined format (“YES” at S34), the operation proceeds to S35.

When it is determined that the communication packet that is received in response to the request for settings mode is not in the predetermined format (“NO” at S34), the operation proceeds to S38. At S38, the controller 20 determines that the communication packet that is received is sent from an apparatus other than the Ethernet converter, such as another information processing apparatus 2 on the hub 3. The controller 20 further causes the display 22 to display a message indicating that the Ethernet converter cannot be set, and the operation ends in error. The message may indicate detection of another apparatus having the same MAC address that is the same as the common MAC address.

As described above, the plurality of information processing apparatuses 2 on the hub 3 may include an information processing apparatus 2 that allows the user to freely set its MAC address. In such case, the information processing apparatus 2 may be assigned with the MAC address that is the same as the common MAC address. Even when there is at least one information processing apparatus 2 that is assigned with the same MAC address as the common MAC address, and such information processing apparatus 2 responds to the request for settings mode, the information processing apparatus 2 that sends the request is able to determine that the response is sent from the information processing apparatus 2 with the same MAC address, by referring to the data format of the communication packet.

While the above-described operation of FIG. 7 allows the information processing apparatus 2 to determine whether there is at least one apparatus assigned with the MAC address that is the same as the common MAC address, the information processing apparatus 2 may not be able to perform the operation of FIG. 7 if a switching hub is used for the hub 3. If the switching hub is used, the switching hub controls a traffic of data by filtering the MAC address. Assuming that a plurality of Ethernet converters are present on the network, the Ethernet converter 1 is not able to monitor a communication packet that is sent from the other Ethernet converter or the other apparatus such that detection of the communication packet would not be possible. In such case, the information processing apparatus 2 is caused to detect whether there is any communication packet that is received from the other Ethernet converter or the other apparatus in response to the request for settings mode, in alternative to the Ethernet converter 1.

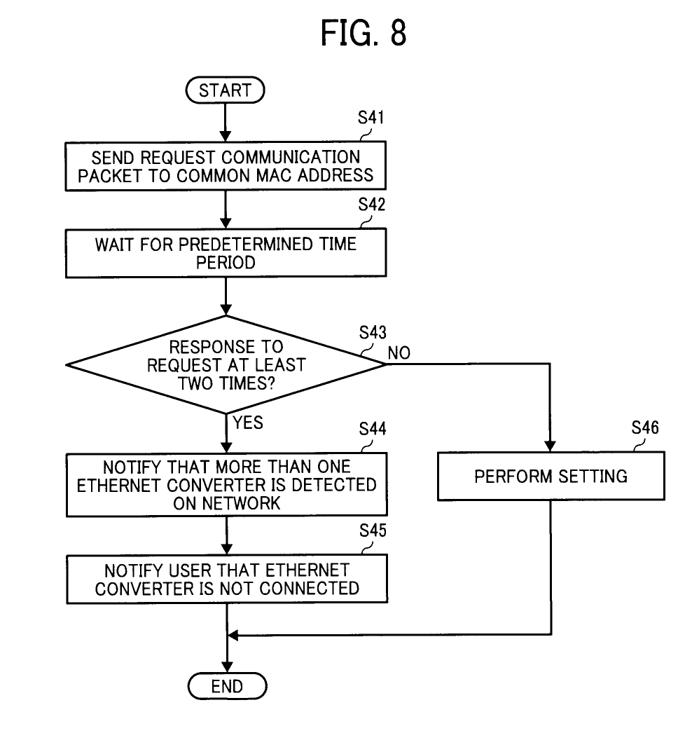

FIG. 8 is a flowchart illustrating operation of detecting another Ethernet converter assigned with the common MAC address or an apparatus assigned with the same MAC address with the common MAC address on the network, according to an example embodiment of the present invention. In this example, it is assumed that the hub 3 is a switching hub, and the user at the information processing apparatus 2 instructs the controller 20 of the information processing apparatus 2 to switch to perform operation of FIG. 8. The operation of FIG. 8 is performed when the information processing apparatus 2 executes the specialized application program to start settings operation of the Ethernet converter 1.

S41 and S42 of FIG. 8 are performed in a substantially similar manner as described above referring to S21 and S22 of FIGS. 6, and S31 and S32 of FIG. 7.

At S43, the controller 20 of the information processing apparatus 2 determines whether a communication packet in response to the request for settings mode is received at least two times. When it is determined that the communication packet is received at least two times (“YES” at S43), the operation proceeds to S44. At S44, the controller 20 causes the Ethernet I/F 23 to send notification indicating that more than one Ethernet converter, or more than one apparatus assigned with the same MAC address as the common MAC address, is detected on the network, to the Ethernet converter 1. More specifically, the Ethernet I/F 23 sends a communication packet of notification addressing the common MAC address.

When the Ethernet converter 1 receives this notification, the CPU 10 determines not to send a communication packet in response to the request for settings mode.

At S45, the controller 20 of the information processing apparatus 2 causes the display 22 to display a message indicating that the Ethernet converter cannot be set, and the operation ends.

When it is determined that the communication packet is received less than two times (“NO” at S43), the operation proceeds to S46 to perform setting operation.

As described above, when a communication packet in response to a request for settings mode is received more than one time, the information processing apparatus 2 sends notification indicating that more than one apparatus having the common MAC address is detected on the network. With this notification, the Ethernet converter 1 is prevented from sending a communication packet in response to the request for settings mode when there is at least one apparatus that sends a response to the request for settings mode. Further, when more than one apparatus having the same MAC address is detected, the user at the information processing apparatus 2 is refrained from continuing setting operation.

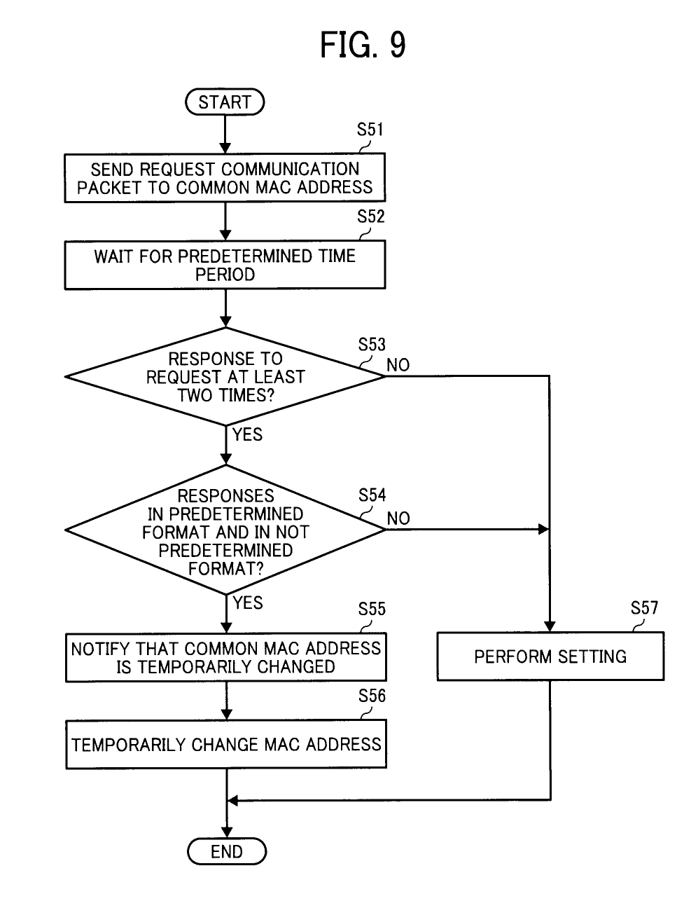

In order to determine whether a communication packet is sent from the other Ethernet converter or the other information processing apparatus, the information processing apparatus 2 may be caused to further check a data format of the communication packet that is received, as described below referring to FIG. 9. If the data format of the communication packet indicates that the response is sent from the other information processing apparatus, the information processing apparatus 2 temporarily changes the common MAC address of the Ethernet converter 1 such that it is not the same as that of the other information processing apparatus that has responded to the request for settings mode.

FIG. 9 is a flowchart illustrating operation of detecting an apparatus assigned with the same MAC address with the common MAC address on the network, according to an example embodiment of the present invention.

S51 to S53 of FIG. 9 are performed in a substantially similar manner as described above referring to S41 to S43 of FIG. 8.

At S53, when it is determined that the communication packet is received at least two times (“YES” at S53), the operation proceeds to S54. At S54, the controller 20 of the information processing apparatus 2 determines whether the received communication packets include a communication packet in the predetermined data format and a communication packet not in the predetermined data format. When it is determined that the received communication packets only include a communication packet in the predetermined data format (“NO” at S54), the controller 20 determines that the communication packets are transmitted from the Ethernet converters, and the operation proceeds to S57 to perform setting operation. Based on determination that the apparatuses responding to the request are both Ethernet converters, the information processing apparatus 2 may perform S44 and S45 of FIG. 8.

When it is determined that the received communication packets include a communication packet in the predetermined data format and a communication packet not in the predetermined data format (“YES” at S54), the operation proceeds to S55. At S55, the controller 20 of the information processing apparatus 2 causes the Ethernet I/F 23 to send notification indicating that the common MAC address will be temporarily changed. More specifically, the Ethernet I/F 23 sends a communication packet of this notification, addressing the common MAC address, which indicates that the common MAC address will be temporarily changed.

At S56, the controller 20 temporarily changes the common MAC address, for example, by adding the value “1” to the lowest digit number of the common MAC address. After changing the common MAC address, the controller 20 of the information processing apparatus 2 sends a communication packet of a request for settings mode that is addressed to the newly set common MAC address.

In this example, the common MAC address may be changed according to a predetermined rule set by the specialized application program. Since the specific rule is only known to the information processing apparatus 2 installed with the specialized application program and the Ethernet converter 1 subject for setting operation, only the Ethernet converter 1 would respond to the communication packet of the request for settings mode that is addressed to the newly set common MAC address.

As described above, even when there is other information processing apparatus 2 assigned with the common MAC address, the information processing apparatus 2 may continue operation of setting the Ethernet converter 1 by temporarily changing the common MAC address.

In any one of the above-described examples, the communication packet to be transmitted to the information processing apparatus 2 in response to the request for settings mode may include information regarding the specific MAC address that is uniquely assigned to the Ethernet converter 1 or an IP address of the Ethernet converter 1. Once the information processing apparatus 2 obtains the specific MAC address or the IP address of the Ethernet converter 1, the information processing apparatus 2 can communicate with the Ethernet converter 1 using the specific MAC address or the IP address.

As described above, the Ethernet converter 1 is assigned with a common MAC address that is common to Ethernet converters, in addition to a specific MAC address that is specific to the Ethernet converter 1. The information processing apparatus 2 sends a request for settings mode, addressing the common MAC address, to the Ethernet converter 1. Since there is no need for the information processing apparatus 2 to change the IP address of the information processing apparatus 2, or there is no need to change a network configuration of the system, the Ethernet converter 1 can be easily set using the information processing apparatus 2.

Further, the Ethernet converter 1 responds to the request for settings mode only when no communication packet in response to such request is detected for a predetermined time period. Even when there is more than one Ethernet converter on the network, the user at the information processing apparatus 2 is able to set one Ethernet converter that has responded to the communication packet first.

The above-described examples describe the case where the information processing apparatus 2 communicates with the Ethernet converter 1 over Ethernet. Alternatively, any one of the above-described methods of setting a communication device, such as the Ethernet converter, is applicable to the other type of communication device that communicates according to the other communication standards. More specifically, any desired communication device may be applied, which allows the information processing apparatus to communicate with another apparatus via wireless network.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

In one example, the present invention may reside in a communication device including: communicating means for transmitting or receiving a communication packet on a network; storing means for storing device settings information of the communication device; settings means for setting the device settings information stored in the storing means; and controlling means for controlling the communicating means, storing means, and setting means. The communication device is assigned with a first address that is uniquely assigned to the communication device and a second address that is commonly assigned to communication devices of the same type. When the communicating means receives a communication packet of a request for setting the device settings information that is addressed to the second address, the controlling means causes the communicating means to transmit the device settings information being stored in the storing means to a sender of the communication packet of the request. When the communicating means receives a communication packet including updated device settings information that is addressed to the second address, the controlling means causes the setting means to change the device settings information being stored to reflect the updated device settings information.

The controlling means determines whether the communication packet addressed to the second address that is received from the sender includes a third address. Only when it is determined that the third address is included, the controlling means causes the communicating means to transmit the device settings information being stored in the storing means to the sender of the communication packet of the request.

The controlling means determines whether the communication packet addressed to the second address that is received from the sender includes identification information. Only when it is determined that the identification information is included, the controlling means causes the communicating means to transmit the device settings information being stored in the storing means to the sender of the communication packet of the request.

In one example, the present invention may reside in a communication system including the above-described communication device and an information processing apparatus to communicate with the communication device through a network. When the communicating means of the communication device receives the communication packet addressed to the second address from the information processing apparatus, the controlling means sends notification indicating the first address to the information processing apparatus through the communicating means. The information processing apparatus includes changing means for changing an address of the information processing apparatus to the first address that is sent from the communication device.

The information processing apparatus further includes determining means. When connection to the network is detected, the determining means sends a communication packet of the request for setting the device settings information that is addressed to the second address. When a communication packet in response to the communication packet of the request is received within a predetermined time period, the determining means determines that the communication device is connected to the network. When the communication packet in response to the communication packet of the request is not received within the predetermined time period, the determining means determines that the communication device is not connected.

In one example, the information processing apparatus further includes changing means for changing a value of the predetermined time period.

In another example, the present invention may reside in a communication device including: communicating means for transmitting or receiving a communication packet to or from an outside apparatus through a network; storing means for storing device settings information used by the communication device to communicate with the outside apparatus; and setting means for setting the device settings information being stored based on information of the communication packet received by the communicating means. The communication device is assigned with a first address that is uniquely assigned to the communication device, and a second address that is commonly assigned to communication devices. The communication device further includes controlling means. When the communicating means receives a communication packet of a request for setting the device settings information that is addressed to the second address, the controlling means monitors a communication packet on the network for a predetermined time period. When the controlling means determines that no communication packet is detected that is sent by another apparatus in response to the communication packet of the request, the controlling means causes the communicating means to send a communication packet in response to the communication packet of the request.

When a communication packet that is sent in response to the communication packet of the request is detected while monitoring the communication packet on the network, the communication device sends a communication packet including notification indicating that a communication packet sent by another apparatus is detected, to a sender of the communication packet.

The controlling means generates the communication packet in a predetermined data format that is determined between the communication device and the sender of the communication packet.

In one example, the present invention may reside in a communication system including the above-described communication device and an information processing apparatus to communicate with the communication device. The information processing apparatus includes transmitting means, receiving means, and controlling means. When the receiving means receives more than one communication packet in response to the communication packet of the request that is sent by the transmitting means, the controlling means causes the transmitting means to send a communication packet including notification indicating that more than one apparatus responding to the request is detected.

When the more than one communication packet includes a communication packet in the predetermined data format and a communication packet not in the predetermined data format, the controlling means causes the transmitting means to send a communication packet of a request for changing the second address, that is addressed to the second address, to the network.

The controlling means of the communication device causes the communication packet in the predetermined data format to include information indicating the first address.

In one example, the present invention may reside in: an information processing apparatus for setting device settings information of a communication device, the communication device being assigned with: a first address that is uniquely assigned to the communication device; and a second address that is commonly assigned to communication devices of the same type, the communication devices including the communication device. The information processing apparatus includes: a network interface to send a communication packet that is addressed to the second address and includes a request for setting device settings information of the communication device, to a network; and a controller to: determine whether more than one communication packet is received in response to the communication packet addressed to the second address within a predetermined time period; and cause the network interface to send a communication packet including notification indicating that more than one apparatus assigned with the same address as the second address is detected, to the network.

The controller of the information processing apparatus is further caused to: determine whether the more than one communication packet that is received in response to the communication packet addressed to the second address includes a communication packet generated in a predetermined data format specific to the communication devices of the same type and a communication packet generated in a data format other than the predetermined data format; cause the network interface to send a communication packet that is addressed to the second address and includes notification indicating that the second address is temporarily changed, to the network; change the second address to a changed second address according to a predetermined rule; and cause the network interface to send a communication packet that is addressed to the changed second address and includes a request for setting device settings information of the communication device, to the network.

In one example, the present invention may reside in: a recording medium storing a plurality of instructions which, when executed by a processor, cause an information processing apparatus to perform a method of setting device settings information of a communication device. The communication device is assigned with: a first address that is uniquely assigned to the communication device; and a second address that is commonly assigned to communication devices of the same type, the communication devices including the communication device. The method includes: obtaining the second address of the communication device; sending a communication packet that is addressed to the second address and includes a request for setting device settings information of the communication device, to a network; determining whether a communication packet that is received in response to the communication packet addressed to the second address includes notification indicating that more than one apparatus assigned with the same address as the second address is detected; and displaying a message that refrains a user at the information processing apparatus from setting the communication device, based on the notification included in the communication packet.

In another example, the method further includes: determining whether the communication packet that is received in response to the communication packet addressed to the second address is generated in a predetermined data format specific to the communication devices of the same type; and displaying a message that refrains the user at the information processing apparatus from setting the communication device, when the communication packet is generated in a data format other than the predetermined data format.

In another example, when the information processing apparatus is connected to the communication device via a switching hub, the method includes: determining whether more than one communication packet is received in response to the communication packet addressed to the second address within a predetermined time period; and sending a communication packet including notification indicating that more than one apparatus assigned with the same address as the second address is detected, to the network.

In another example, the method further includes: determining whether the more than one communication packet that is received in response to the communication packet addressed to the second address includes a communication packet generated in a predetermined data format specific to the communication devices of the same type and a communication packet generated in a data format other than the predetermined data format; sending a communication packet that is addressed to the second address and includes notification indicating that the second address is temporarily changed, to the network; changing the second address to a changed second address according to a predetermined rule; and sending a communication packet that is addressed to the changed second address and includes a request for setting device settings information of the communication device, to the network.

In one example, the present invention may reside in: a communication system including a communication device assigned with: a first address that is uniquely assigned to the communication device; and a second address that is commonly assigned to communication devices of the same type, the communication devices including the communication device, and an information processing apparatus connected to the communication device through a network. The information processing apparatus includes: a network interface to send a communication packet that is addressed to the second address and includes a request for setting device settings information of the communication device, to the network; a controller to: determine whether a communication packet that is received in response to the communication packet addressed to the second address includes notification indicating that more than one apparatus assigned with the same address as the second address is detected; and cause a display device to display a message that refrains a user at the information processing apparatus from setting the communication device, based on the notification included in the communication packet.

What is claimed is:

1. A communication device, comprising:
a memory to store a first address that is uniquely assigned to the communication device and a second address that is commonly assigned to communication devices of the same type, the communication devices including the communication device;
a network interface to receive a communication packet addressed to the second address from an outside apparatus through a network, the communication packet including a request for setting device settings information of the communication device; and
a controller to:
monitor a communication packet on the network for a predetermined time period counted from when the communication packet addressed to the second address is received by the network interface to detect a communication packet that is transmitted from another apparatus in response to the communication packet addressed to the second address; and
cause the network interface to send a communication packet including current device settings information of the communication device, in response to the communication packet addressed to the second address, when no communication packet that is transmitted from another apparatus is detected within the predetermined time period.

2. The communication device of claim 1, wherein, when at least one communication packet that is transmitted from another apparatus is detected within the predetermined time period,
the controller causes the network interface to send a communication packet including notification indicating that more than one apparatus assigned with the same address as the second address is detected on the network, to the outside apparatus that sends the communication packet.

3. The communication device of claim 1, wherein the controller sends the communication packet to the outside apparatus in a predetermined data format specific to the communication devices of the same type.

4. The communication device of claim 1, wherein the predetermined time period for monitoring is a value specific to the communication device, which differs from a predetermined time period of any one of the other communication devices of the same type.

5. The communication device of claim 1, wherein the communication packet further includes the first address of the communication device, the first address being used by the information processing apparatus to communicate with the communication device on the network.

6. A communication system, comprising:
the communication device of claim 1; and
an information processing apparatus connected to the communication device through the network, wherein the information processing apparatus includes:
a network interface to send a communication packet that is addressed to the second address and includes a request for setting device settings information of the communication device, to the network; and
a controller to:
determine whether a communication packet that is received in response to the communication packet addressed to the second address includes notification indicating that more than one apparatus assigned with the same address as the second address is detected; and
cause a display device to display a message that refrains a user at the information processing apparatus from setting the communication device, when the received communication packet includes the notification.

7. The communication system of claim 6, wherein the controller of the information processing apparatus is further configured to:
determine whether the communication packet that is received in response to the communication packet addressed to the second address is generated in a predetermined data format specific to the communication devices of the same type, wherein
when the communication packet is generated in a data format other than the predetermined data format, the message displayed by the display device includes a message indicating that an apparatus assigned with the same address with the second address is detected, and
when the communication packet is generated in the predetermined format, the message displayed by the display device includes a message indicating that more than one communication device assigned with the second address is detected.

8. An information processing apparatus for setting device settings information of a communication device, the communication device being assigned with: a first address that is uniquely assigned to the communication device; and a second address that is commonly assigned to communication devices of the same type, the communication devices including the communication device, the information processing apparatus comprising:
a network interface to send a communication packet that is addressed to the second address and includes a request for setting device settings information of the communication device, to a network; and
a controller to:
determine whether more than one communication packet is received in response to the communication packet addressed to the second address within a predetermined time period; and
cause the network interface to send a communication packet including notification indicating that more than one apparatus assigned with the same address as the second address is detected, to the network, when more than one communication packet is received.

9. The communication system of claim 8, wherein the controller of the information processing apparatus is further configured to:
determine whether the more than one communication packet that is received in response to the communication packet addressed to the second address includes a communication packet generated in a predetermined data format specific to the communication devices of the same type and a communication packet generated in a data format other than the predetermined data format, and
when the more than one communication packet includes the communication packet in the predetermined data format and the communication packet in the data format other than the predetermined data format, the controller is further configured to:
cause the network interface to send a communication packet that is addressed to the second address and includes notification indicating that the second address is temporarily changed, to the network;
change the second address to a changed second address according to a predetermined rule; and
cause the network interface to send a communication packet that is addressed to the changed second address and includes a request for setting device settings information of the communication device, to the network.

10. A method of setting device settings information of a communication device using an information processing apparatus, the communication device being assigned with: a first address that is uniquely assigned to the communication device; and a second address that is commonly assigned to communication devices of the same type, the communication devices including the communication device, the method comprising:
sending a communication packet addressed to the second address from the information processing apparatus to the network, the communication packet including a request for setting device settings information of the communication device;
monitoring, at the communication device, a communication packet on the network for a predetermined time period counted from when the communication packet addressed to the second address is received at the communication device, to detect a communication packet that is transmitted from another apparatus in response to the communication packet addressed to the second address; and
sending a communication packet including current device settings information of the communication device in response to the communication packet addressed to the second address, from the communication device to the information processing apparatus, when no communication packet that is transmitted from another apparatus is detected at the communication device within the predetermined time period.

11. The method of claim 10, further comprising:
determining, at the information processing apparatus, whether a communication packet is received in response to the communication packet addressed to the second address within a predetermined time period.

12. The method of claim 11, further comprising:
determining, at the information processing apparatus, whether the received communication packet includes notification indicating that more than one apparatus assigned with the same address as the second address is detected; and
displaying a message that refrains a user at the information processing apparatus from setting the communication device, when the received communication packet includes the notification.

13. The method of claim 12, further comprising:
determining, at the information processing apparatus, whether the received communication packet is generated in a predetermined data format specific to the communication devices of the same type, wherein
when the communication packet is generated in a data format other than the predetermined data format, the message displayed by the displaying includes a message indicating that an apparatus assigned with the same address with the second address is detected, and
when the communication packet is generated in the predetermined format, the message displayed by the displaying includes a message indicating that more than one communication device assigned with the second address is detected.

14. The method of claim 11, wherein, when the information processing apparatus is connected to the communication device via a switching hub, the method further comprises:
determining, at the information processing apparatus, whether more than one communication packet is received in response to the communication packet addressed to the second address within the predetermined time period; and
sending a communication packet including notification indicating that more than one apparatus assigned with the same address as the second address is detected, from the information processing apparatus to the network, when more than one communication packet is received.

15. The method of claim 14, further comprising:
determining, at the information processing apparatus, whether the more than one communication packet that is received in response to the communication packet addressed to the second address includes a communication packet generated in a predetermined data format specific to the communication devices of the same type and a communication packet generated in a data format other than the predetermined data format, wherein
when the more than one communication packet includes the communication packet in the predetermined data format and the communication packet in the data format other than the predetermined data format, the method further comprises:
sending a communication packet that is addressed to the second address and includes notification indicating that the second address is temporarily changed, from the information processing apparatus to the network;
changing, at the information processing apparatus, the second address to a changed second address according to a predetermined rule; and
sending a communication packet that is addressed to the changed second address and includes a request for setting device settings information of the communication device, from the information processing apparatus to the network.
